(19) United States
(12) Patent Application Publication
(10) Pub. No.: US 2010/0077435 A1
(43) Pub. Date: Mar. 25, 2010

(54) System and method for smart trick mode display

(75) Inventors: Kunal Kandekar, Morrisville, NC (US); Richard J. Walsh, Raleigh, NC (US); Ravi Reddy Katpelly, Durham, NC (US)

Correspondence Address: AKERMAN SENTERFITT, 8100 BOONE BOULEVARD, SUITE 700, VIENNA, VA, 22182-2683, US

(73) Assignee: Concert Technology, Durham, NC (US)

(21) Appl. No.: 12/232,805

(22) Filed: Sep. 24, 2008

(51) Int. Cl. H04N 5/445

(52) U.S. Cl. 725/61

(57) ABSTRACT

A system and method for smart trick mode display which is aware of content and metadata, user context and user interests, and selects frames to display during trick mode that may be of interest to the user, and filters frames that the user might not wish to see even inadvertently. More specifically, the media system and method for smart trick mode display analyzes a recorded video content during a trick mode playback of the recorded video; and identifies segments of the content that are least one of interest to the user or should not be displayed to the user. The system may then select keyframes or a short sub-segment of the segment of interest to the user and then either displays the keyframes or sub-segments in a manner so as to catch the user's attention, or specifically not display any keyframes or sub-segments having content that the user does not wish to see.

### FIELD OF THE INVENTION

The present invention relates to a media system for and method of smart trick mode display which is aware of the content metadata, user context and user interests, and selects frames to display during trick mode that may be of interest to the user, and filters frames that the user might not wish to see even inadvertently.

### BACKGROUND OF THE INVENTION

In general, video recorders and players such as digital video disc (DVD)/BluRay players, set-top boxes (STBs) and TiVos allow users to move through recorded video content as they desire, by letting the user, for example, fast-forward, rewind or skip through sections of the video. Video playback during these actions is often referred to as “trick mode” playback.

More specifically, during trick mode playback, the display is usually arbitrary, typically displaying video frames that reflect the current instantaneous location in the video while moving through it, or displaying the video at different speeds. The display of the video frames is not content-aware and user-aware and could often skip over content that may be of interest to the user without displaying a single frame of that content. Alternatively, it is possible during trick mode display to inadvertently display a frame that the user does not wish to see or that should be avoided, such as a spoiler segment or inappropriate content.

### SUMMARY OF THE INVENTION

The present invention relates to a system and method for smart trick mode display. More specifically, the smart trick mode display system is aware of the content metadata, user context and user interest, and selects frames to display during trick mode that may be of interest to the user, and filters frames that the user would not want to see even inadvertently.

According to one aspect of the present invention, the smart trick mode display system analyzes the content being rewound, skipped or fast-forwarded through, and then determines which segments of the content may be of particular interest to the user.

According to another aspect of the present invention, the smart trick mode display system analyzes the content being rewound, skipped or fast-forwarded through, and then determines which segments of the content should not be displayed to the user.

According to a further aspect of the present invention, the smart trick mode display system selects keyframes or short sub-segments of the segment of interest to the user, and displays the keyframes or the sub-segments of the segment of interest to the user and emphasizes the keyframes or sub-segments to catch the user's attention.

According to a still further aspect of the present invention, the smart trick mode display system selects keyframes or short sub-segments that may include content that the user does not wish to see, and then specifically does not display any keyframes or sub-segments from this content as the user wishes to avoid viewing the same.

Thus, the present invention provides a media system with smart trick mode display, comprising: a control system operative to: provide playback of a media item in a trick play mode; analyze the content of the media item during the trick mode playback of the media item; identify at least one segment of the content that is of interest to a user; and display the at least one segment that is identified as being of interest to the user with emphasis to catch the user's attention during the trick mode playback of the media item. Alternatively or in addition, the system can identify at least one segment of the content that is objectionable to a user and therefore should not be displayed to the user; and avoid the at least one segment that is identified as being objectionable to the user during the trick play mode playback of the media item.

The present invention also provides a mobile device comprising a communication interface communicatively coupling the mobile device to a media player; and a control system as described above associated with the communication interface.

The present invention also contemplates a computer readable medium comprising a program for instructing a media system to perform the above-described smart trick mode display.

According to yet another aspect of the present invention, the smart trick mode display system interprets any subsequent user action in context of the most recent keyframe and/or sub-segment displayed, for example, rewind, resume play, etc., and positions the player at the beginning of that segment.

According to the present invention, the content of interest to the user, whether desired or undesired, may be identified by analyzing and managing any combination of: user configurations; media content metadata; user profile and interests; user video history; viewing behavior history of a current user, prior users, similar users, and/or people in a user's social network; or other techniques known in the art.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 illustrates a media system for smart trick play mode according to an exemplary embodiment of the present invention;

FIG. 2 is a flow chart that illustrates the operation of a media system for smart trick play mode according to an exemplary embodiment of the present invention;

FIG. 3 illustrates an example of a smart trick mode display emphasizing certain content that may be of interest to a user; and

FIG. 4 illustrates a media system for smart trick play mode according to another exemplary embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

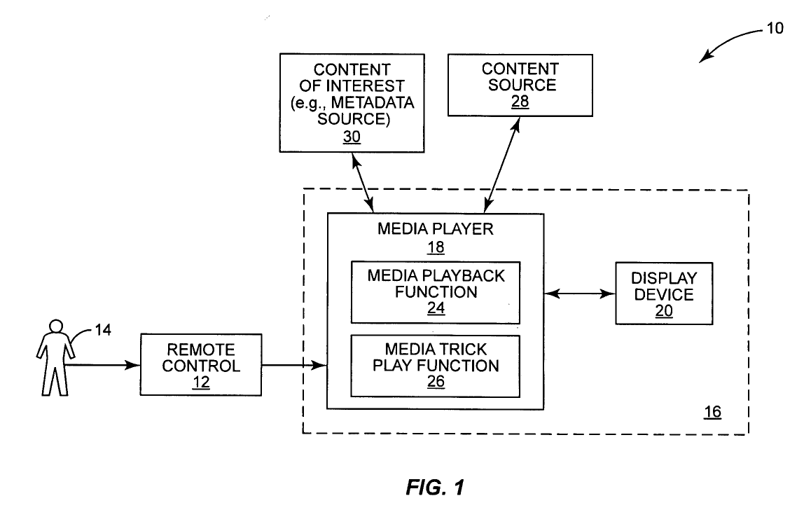

FIG. 1 illustrates a media system for smart trick mode display 10 according to an exemplary embodiment of the present invention. In general, the media system for smart trick mode display 10 includes a remote control 12 having an associated user 14 and a media playback system 16. In this exemplary embodiment, the media playback system 16 includes a media player 18 and a display device 20.

The media player 18 may be, for example, a set-top box (STB) for playing digital television content received from a television content provider, a Digital Video Recorder (DVR) for playing previously recorded video content such as previously recorded television content received from a television content provider, an Apple TV® device for playing downloaded content that has been purchased or rented from a remote media distribution service such as the Apple® iTunes® store, a Digital Versatile Disc (DVD) player, a personal computer, or the like. The media player 18 may be connected to the display device 20 via any desired audio/video connection such as, for example, a High Definition Multimedia Interface (HDMI) connection, a Digital Video Interface (DVI) connection, a coaxial cable connection, or the like. The display device 20 may be, for example, a television (TV). In an alternative embodiment, the display device 20 may be incorporated into the media player 18.

The media player 18 includes a media playback function 24 and a media trick play function 26, each of which may be implemented in software, hardware, or a combination thereof and comprise a control system. The media playback function 24 generally operates to provide playback of media items obtained from a content source 28. In the preferred embodiment, the media items are video items. As such, the media playback function 24 provides playback of the video items and presentation of the video items to the user 14 and any other nearby users via the display device 20. The content source 28 varies depending on the particular implementation of the media player 18. For example, if the media player 18 is a STB, then the content source 28 may be a television content distribution network such as a Cable Television (CATV) network. As another example, if the media player 18 is a DVD player, then the content source 28 is a DVD. As a final example, if the media player 18 is a device such as an Apple TV® device, then the content source 28 may be a remote media distribution service such as the Apple® iTunes® store, where the media player 18 has access to the remote media distribution service via a network such as, for example, the Internet.

As discussed below, the media trick play function 26 identifies the media content of interest to the user by analyzing and matching any combination of, for example: 1) user configurations, 2) metadata describing media content of the media item from a content metadata source, 3) a user's profile and interests, 4) a user's video history, 5) viewing behavior history of the current user, prior users, similar users and/or people in the user's social network, and 6) any other techniques known in the art.

For example, as shown in FIG. 1, metadata describing media content of the media item from a content metadata source 30 is utilized to identify the media content which may be of interest to the user 14. The metadata may be, for example, tags, annotations, a script or lyrics for the media item, closed-captioning information, sub-titles, or the like. Moreover, the media trick play function 26 may also utilize a combination of audio and frame analysis techniques. For example, to detect violent content, in addition to frame analysis techniques to detect, for example, smoke or blood pixels, the system may also utilize audio analysis techniques, for example, to detect gunshot sounds.

More specifically, in one embodiment, the metadata includes tags directly identifying potentially objectionable content in the media item. The tags may be defined by a producer of the media item, the user 14, or the like. Each tag may be associated with a point in time or a time segment during playback of the media item that includes potentially objectionable content. For example, if the types of objectionable content that may be selected by the user 14 are profane language, violent content, scary content, and sexual situations, the metadata may include tags identifying each occurrence of those types of objectionable content in the media item.

In addition or alternatively, the metadata may include annotations provided by the user 14, other users that have consumed (i.e., viewed, listened to, etc.) the media item, a producer of the media item, or the like. The annotations are generally keywords, comments, or the like associated with a particular point or time segment during playback of the media item. The annotations may be defined by the producer of the media item, the user 14, by a number of users that have previously viewed the media item, or the like. In addition or alternatively, the metadata may include a script for the media item if the media item is a video item such as a movie or television program, lyrics if the media item is a song, closed-captioning information if the media item is broadcast television content, or subtitles if the media item is a video item such as a movie.

The content metadata source 30 may vary depending on the particular implementation. In one embodiment, if the media item is provided according to a standard allowing for annotations such as MPEG-7, the content metadata source 30 may be the same as that of the media item where the annotations are provided in connection with the media item according to the standard. Similarly, if the media item has closed-captioning or subtitles, the content metadata source 30 may be the same as that of the media item. Alternatively, the content metadata source 30 may be a remote server storing metadata for a number of media items, where the media trick play function 26 queries the remote server to obtain the metadata for the media item. Note, however, that the content metadata source 30 may be any source of metadata that may be used to directly or indirectly detect content in the media item which may be of interest to the user 14 or for content that the user wants to specifically avoid.

The present invention is not limited to detecting content based on metadata for the media item. For example, rather than identifying the content based on metadata for the media item, the media trick play function 26 may analyze the media item itself to identify the content of interest or to be avoided. For instance, if the user wishes to avoid profane language and the media item is a video or song, the media trick play function 26 may utilize audio analysis techniques to identify profane language in the media item. More specifically, the media trick play function 26 may perform speech-to-text conversion and then compare the text to a list of profane language terms or phrases in order to identify profane language in the media item. In a similar manner, if the user wishes to avoid any violent content and the media item is a video such as a movie, the media trick play function 26 may utilize frame analysis techniques to identify frames or segments 20 of the media item containing violence. Another example of audio analysis would be to employ laughter detection to identify funny scenes in a sitcom, wherein if the system detects canned laughter such that something funny has just happened, this would indicate that the few seconds just prior to the canned laughter may be desirable to a user, especially if his profile/preferences emphasize comedy.

By way of example, the media trick play function 26 first obtains information identifying and describing a number of segments of the media item. The information identifying and describing the segments of the media item may be obtained from the content source 30 in the form of a remote source such as, for example, a streaming media source. For each segment, the information identifying and describing the segments of the media item includes information identifying a point in playback of the media item corresponding to a starting point of the segment and, optionally, a point in playback of the media item corresponding to the ending point of the segment. The segments of the media item may be predefined by a producer or creator of the media item. Alternatively, the streaming media source identifies the segments of the media item. More specifically, the streaming media source may perform a frame analysis process to identify the segments of the media item. For example, the frame analysis may detect dark frames, such as essentially black frames, and determine that the dark frames represent a transition from one segment of the media item to another segment of the media item. In addition or alternatively, the media source may identify the segments of the media item by analyzing metadata and/or annotations available for the media item. For example, the producer or creator of the media item may provide metadata for the media item that describes the content of the media item but does not explicitly identify the segments of the media item. The streaming media source may analyze the metadata to identify the segments of the media item. In addition or alternatively, users that have previously viewed the media item may create annotations for the media item, and the streaming media source may analyze the annotations to identify the segments of the media item. Still further, the streaming media source may identify the segments by dividing the media item into segments according to a desired segment playback length or data size or divide the media item into a defined number of segments of equal playback length or data size.

In addition, for each segment, the information identifying and describing the segment includes information describing the content of the segment of the media item. For example, the information may describe the segment as containing an action scene, a romantic scene, or the like. As another example, the information describing the segment may include a list of actors or actresses appearing in the segment and/or a description of activities that take place in the segment. The information describing the content of the segments of the media item may be information provided by a producer or creator of the media item, information such as annotations provided by one or more users that have previously viewed the media item, or the like, or any combination thereof.

Once the information identifying and describing the segments of the media item is obtained, the media trick play function 26 selects one or more segments of interest during trick play mode from the segments of the media item based on one or more criteria. The one or more criteria may be, for example, user preferences defined by the user 14, actions taken by the user 14 during the current playback of the media item, a playback history of the user 14 for one or more previous playbacks of the media item, playback history for the user 14 for one or more other media items, a playback history of one or more users that have previously viewed the media item, a playback history of one or more other users in a social network of the user 14 that have previously viewed the media item, heuristics or settings provided by the streaming media source and/or the producer or creator of the media item, information contained in a user profile of the user 14 maintained by a social networking service such as, for example, a social networking website, bandwidth availability and bandwidth requirements for obtaining the segments of the media item, or the like.

The user preferences defined by the user 14 may, for example, include one or more keywords associated with content in which the user 14 has an interest, names of one or more actors or actresses in which the user 14 has an interest, names of one or more characters in a particular media item in which the user 14 has an interest, types of scenes in which the user 14 has an interest, or the like. The media trick play function 26 may compare the user preferences of the user 14 to the information describing the segments of the media item to select the segments of interest during trick play mode from the streaming media source.

As discussed below, the actions taken by the user 14 during the current playback of the media item may be utilized by the media trick play function 26 to select the segments of interest during trick play mode from the streaming media source. For example, if the user 14 skips to a particular segment of the media item and then views that segment, the media trick play mode function 26 may select similar segments of the media item as segments of interest during trick play mode from the streaming media source. Note that a priority assigned to the segment skipped to by the user 14 as well as priorities assigned to similar segments of the media item may be increased. Similarly, if the user 14 skips over a particular segment of the media item, the media trick play function 26 may ensure that similar segments of the media item are not selected as segments of interest during trick play mode from the streaming media source or may reduce the priority assigned to similar segments.

The media trick play function 26 may additionally or alternatively use the playback history of the user 14 for one or more previous playbacks of the media item to select the segments of interest during trick play mode from the streaming media source. More specifically, the playback history may identify segments of the media item previously viewed by the user 14, skipped by the user 14, skipped to by the user 14, or the like. The media trick play function 26 may then identify segments of the media item previously skipped to and viewed by the user 14 in the one or more previous playbacks of the media item as segments of interest during trick play mode from the streaming media source.

The media trick play function 26 may additionally or alternatively use the playback history of the user 14 for one or more other media items. Again, the playback histories may identify segments of the media items viewed by the user 14, segments of the other media items skipped by the user 14, segments of the other media items skipped to by the user 14, or the like. As an example, the media trick play function 26 may then identify segments of the media item that are similar to segments of the other media item previously skipped to and viewed by the user 14 as segments of interest during trick play mode from the streaming media source.

In a similar manner, the media trick play function 26 may use playback histories for previous playbacks of the media item by one or more other users or one or more other users within a social network of the user 14 to select the segments of interest during trick play mode from the streaming media source. Again, the playback histories of the other users may identify segments of the media item previously viewed by the other users, skipped by the other users, skipped to by the other users, or the like. In general, the media trick play function 26 may then identify segments of the media that were of interest to the other users, not of interest to the other users, or the like. For example, segments of the media item previously skipped to and viewed by a threshold number or percentage of the other users may be identified as segments of interest to the other users. The media trick play function 26 may then identify segments of the media item previously skipped to and viewed by a threshold number or percentage of the other users as segments of interest during trick play mode from the streaming media source. In another embodiment, the playback histories of the other users may be weighted based on, for example, degree of separation from the user 14 in the social network of the user 14, similarity of profiles of the other users and the profile of the user 14, or the like. The weighting may then be considered when determining whether, for example, segments skipped to and viewed by the other users are likely of interest to the user 14.

In addition or alternatively, the media trick play function 26 may select the one or more segments of interest during trick play mode from the streaming media source based on heuristics or settings provided by the streaming media source. The heuristics or settings may be defined by the streaming media source, a producer or creator of the media item, or the like. The heuristics or settings may define one or more segments of interest during trick play mode for all users. In addition or alternatively, the heuristics or settings may include one or more rules defining segments of interest during trick play mode for classes of users. A class of users may be defined based on demographic information, geographic information, records of media items previously viewed by the users, or the like. For example, the heuristics or settings may include one or more rules stating that action scenes are to be selected for male users in the age range of 20-40 years old. Thus, when selecting segments of interest based on such heuristics, the media trick play function 26 may first select a class of users from the classes of users defined by the heuristics to which the user 14 belongs. One or more of the segments identified for the class of users to which the user 14 belongs may then be selected as the segments of interest during trick play mode.

Still further, the media trick play function 26 may also consider information contained in a user profile of the user 14 hosted by a social networking service such as a social networking website. The profile of the user 14 may identify a favorite actor or actress of the user 14, a favorite movie of the user 14 from which the interests of the user 14 may be inferred, a favorite movie or television character of the user 14, or the like.

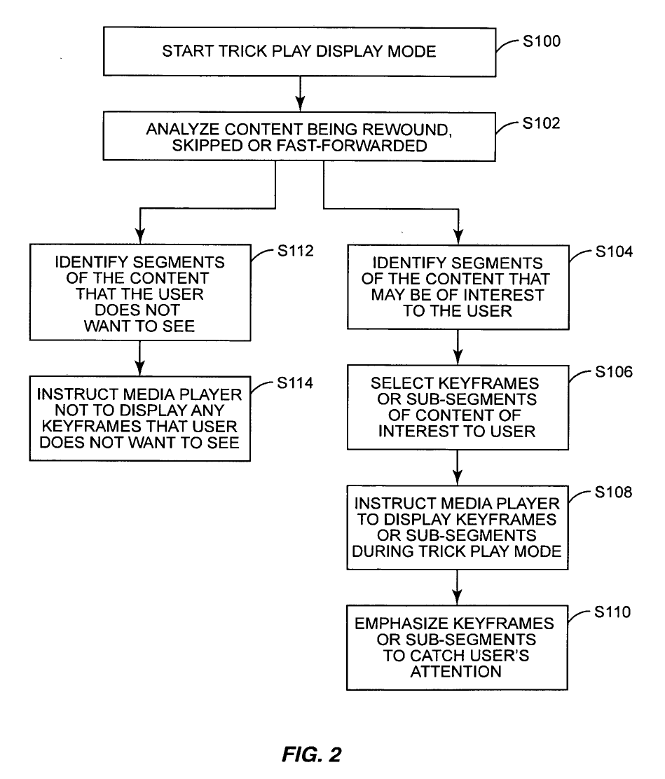

FIG. 2 illustrates the operation of the media system for smart trick mode display of FIG. 1 according to an exemplary embodiment of the present invention. First, the user 14 will start the trick play display mode by pressing an appropriate key on the remote control 12 (step S100). Next, the media trick play function 26 begins to analyze the content being rewound, skipped or fast-forwarded during the trick mode playback (step S102). As described above, the content of interest to the user 14 may be identified by analyzing and managing any combination of user configurations, media content metadata, user profile and interests, user video history, viewing behavior history of the current user, prior users, similar users, and people in the user's social network, as well as other techniques known in the art. Also, while step S102 shows the media trick play function 26 beginning the analysis of the content during the trick mode playback, the present invention also contemplates performing such analysis beforehand. For example, such content analysis could be carried out at the time of recording, or further when the user switches the channel, the system analyzes the channel for current/upcoming content that the user prefers, or still further the content is analyzed at the cable head-end using the user's preferences, etc.

The system then identifies segments of the content that may be of interest to the user 14 (step S104). After identifying a particular segment of the media content that may be of interest to the user 14, the system then selects keyframes or sub-segments of the content of interest to the user (step S106). The system then instructs the media player 18 to display the selected keyframes or sub-segments during the trick play mode on the display device 20 which, as noted above, may be, for example, a TV (step S108). Finally, the system then operates to emphasize or highlight the identified relevant keyframes or sub-segments of interest (step S110).

The step S110 of emphasizing or highlighting the identified or selected relevant keyframes or sub-segments of interest may be carried out in a number of different ways. More specifically, the selected keyframes or sub-segments are emphasized to differentiate them from the non-relevant frames, for example, by 1) pausing at the relevant keyframe/content for a longer time than other frames, 2) playing a short sub-segment of the content of interest at normal speed, or 2× the normal speed, 3) marking the relevant keyframe with an icon, or also utilizing the icon to indicate why a frame is relevant (e.g., a smiley icon indicates that it is a funny scene, a ninja icon indicates a fight scene, etc.), 4) extracting the keyframe and overlaying it in a Picture-In-Picture (PIP) format over the other frames, or utilizing frame analysis techniques to find appropriate regions within the frames where the extracted keyframes can be overlaid (e.g., a darker keyframe overlaid on a white section of the frame is easily noticeable), 5) displaying the keyframe or playing the segment on a supplementary mobile device, such as a user's iPhone® (as will be discussed in more detail below), 6) de-emphasizing the non-relevant frames (e.g., by blurring, etc.), 7) using the audio on the TV (e.g., a “beep-beep” sound), 8) sending a notification to a mobile device to make a sound or vibrate the device, 9) or other techniques known in the art. Of course, the various ways of highlighting or emphasizing noted above can be utilized together. For example but not limited thereto, the use of an icon can be employed together with, for example, options 1, 2, 4, etc.

Other possible ways of highlighting the identified or selected relevant keyframes or sub-segments include displaying them amongst other non-relevant frames as normal, with the user being expected to notice the selected relevant frames.

Still further, the present invention also contemplates the situation where multiple users are present, and that the system thus sends disparate notifications based on the various users' respective interests. For example, a first mobile device receives a video frame of a beer commercial for a first adult user, whereas a second mobile device receives a vibration for a commercial relating to a home cleaning product for a second adult user, and still further the TV receives a frame of a kids' cartoon for a child who is present in the room.

The keyframes or sub-segments used to represent the segment of interest that are displayed to the user may be selected using keyframe analysis or other video analysis techniques.

As further illustrated in FIG. 2, during the trick play display mode, the user 14 may wish to also identify segments of the content that the user does not want to see, such as the objectionable content discussed above (step S112). The system then instructs the media player 18 not to display any keyframes that the user does not want to see (step S114). The media trick play function 26 utilizes any of the above-discussed techniques to identify objectionable content and then filters the same so that the user is not subjected to any of such objectionable content during the trick play mode.

Of course, in a multi-person situation where some content is acceptable whereas other content is objectionable for different users, the media trick play function 26 can operate so that the TV skips the frames associated with objectionable segments, for example, when children are watching, while a parent's mobile device would include a frame from that section.

Also, while various objectionable content was identified above, the present invention also contemplates content which may simply be “undesirable” to the user. For example, undesirable content may include content such as an advertisement, a particular scene from a movie or TV program, an actor that the user dislikes, etc.

The following are examples of the use of the present invention. Of course, the examples are in no way meant to be limiting and are presented simply for a better understanding of the present invention.

### EXAMPLE 1

### Recorded Content

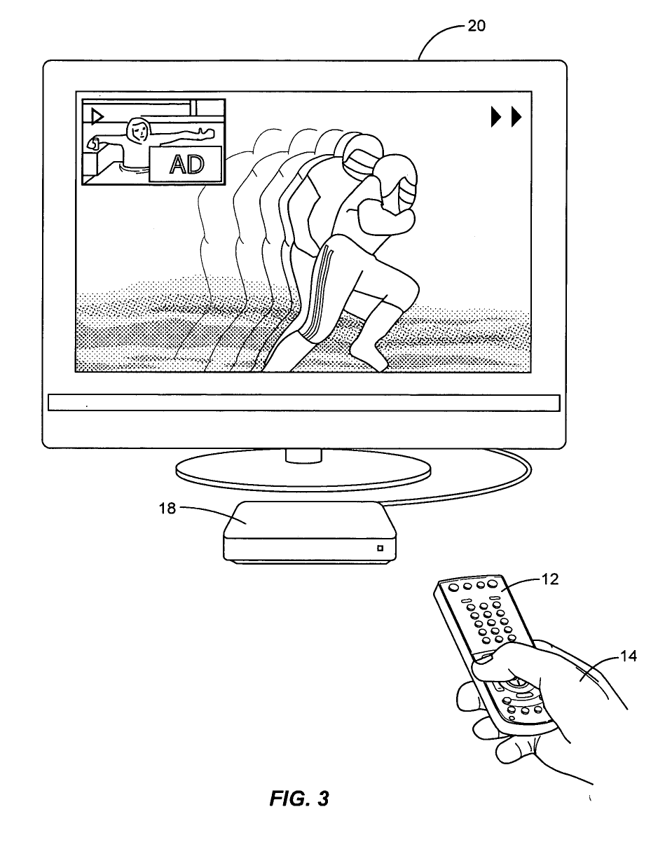

The user has recorded a football game for later viewing during a more convenient time. Later, the user is anxious to watch the recorded game and therefore skips through the advertisements to get to the game. The trick mode display shows frames at, for example, 30 second intervals. The media trick play function 26 of the DVR analyzes metadata of all the current content, which are downloaded after the game. During the trick mode display, the user skips over a particularly popular beer advertisement. The media trick play function 26 of the DVR is aware that the user likes this particular beer, and the user has previously shown interest in such a beer advertisement (e.g., laughter detection, etc.). The media trick play function 26 of the DVR is also aware that the majority of the users who watched the advertisement approved of it (again, based on laughter detection, viewer feedback, etc.). The media trick play function 26 of the DVR extracts a keyframe from the skipped advertisement depicting a caveman holding a beer can, and displays the keyframe in an overlay PIP format in the corner of the TV screen as illustrated in FIG. 3.

The user notices the overlaid keyframe after two seconds, finds it interesting, and then presses play on the remote control 12. The DVR then skips back to the exact beginning of the advertisement and starts playback from there. In this way, the user is able to view the entire advertisement for which the media smart trick play mode display determined may be of interest to the user.

### EXAMPLE 2

### Movie Content

The user is watching his favorite movie for the 14^{th} time. The user skips over all the non-action scenes, and the trick mode display shows everything in fast forward. During the trick mode, the user approaches a three second clip he has always found amazing where the action hero dismantles a gun from another person with one hand. The media trick play function 26 of the media player checks the user's previous viewing behavior and notices that he has rewound and replayed that section a number of times in the past. The user keeps fast-forwarding through that scene. However, the media trick play function 26 of the media player detects that the user may want to see that particular clip based on past viewing behavior. Quickly, the media player slows down the playback speed to normal for just that three second clip, and resumes trick mode display thereafter. The user is still amazed how the action hero performed the stunt, and presses “repeat” on the remote control 12 to replay the scene once again.

Of course, instead of playing back the desired clip at normal speed, the media trick play function 26 could utilize, for example, a speed bump in the fast-forward operation, or the desired clip could be played in a PIP window, etc.

### EXAMPLE 3

### Inappropriate Content Avoidance I:

The user is watching a movie with his children. Unfortunately, the movie contains several violent/scary scenes which the user does not want his children to view. The user presses fast forward to avoid the scenes. The media trick play function 26 of the DVR is aware that the user does not wish to see certain violent/scary scenes when viewing movies. Accordingly, the media trick play function 26 of the DVR detects that the movie is approaching a segment with violence and therefore instructs the trick mode system to specifically avoid that segment while the user is fast-forwarding through it. An alert system for alerting the user of upcoming objectionable content, such as on the user's iPhone®, will be discussed in more detail below.

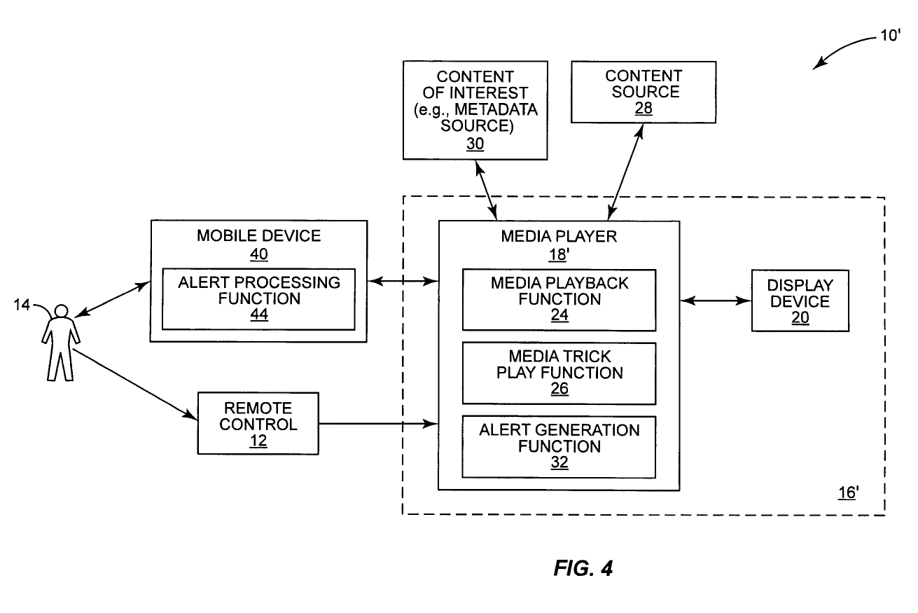

FIG. 4 illustrates a further exemplary embodiment of a media system for smart trick mode display 10′ according to the present invention and which includes an advance alert generation function 32 for providing advance content alerts to a mobile device 40. Note that in this embodiment, like elements are denoted by like reference numerals. For example, the advance content alert may be sent to the mobile device 40 having an associated user 14 by a media playback system 16′. In this embodiment, the media playback system 16′ includes a media player 18′ and a display device 20. The mobile device 40 may be, for example, a mobile telephone such as the Apple® iPhone®, a portable media player such as the Apple® iPod® Touch, or the like. The mobile device 40 is preferably connected to the media player 18′ via a local wireless connection such as, for example, a Bluetooth® connection, an IEEE 802.11 connection, or the like. However, the mobile device 40 may be connected to the media player 18′ via any type of wireless connection provided via any type or combination of Wide Area Network (WAN), Local Area Network (LAN), Personal Area Network (PAN), or the like. In this embodiment, the mobile device 40 includes an alert processing function 44 for processing advance content alerts received from the media player 18′, as discussed below. The alert processing function 44 may be implemented in software, hardware, or a combination thereof. A more detailed description of a suitable advance content alert system can be found in co-pending U.S. application Ser. No. 12/119,625, filed on May 13, 2008, the contents of which are incorporated herein by reference.

In the exemplary embodiment of FIG. 4, the alert generation function 32 and the alert processing function 44 simply add a further dimension to the embodiment of FIGS. 1-3 by serving as a communication interface permitting the user 14 to interact with the media player 18′ via the mobile device 40 in addition to viewing the screen of the display device 20. For example, the particular keyframes or segments of interest to the user 14 during the trick mode playback may be transmitted to and displayed on a mobile device 40. Moreover, the user 14 can send user commands to the media player 18′ by, for example, text messaging particular commands during trick mode playback. Thus, for example, if the user 14 wishes to view an entire segment of interest based on the keyframe that has appeared on the display of his mobile device, such as on an iPhone®, then the user would simply send a text message from the mobile device 40 to the media player 18′ instructing the same to skip back to the beginning of the entire segment and start playback there.

Another application of the exemplary embodiment of FIG. 4 is for the user 14 to actually receive an advance notice or alert of, for example, video content either desired or objectionable during the normal playback of the video directly to the mobile device 40 via the alert generation function 32 and the alert processing function 44.

### EXAMPLE 4

### Spoiler and Inappropriate Content Avoidance II:

This example is similar to Example 3 except that the user now has a mobile device 40 which interacts with the media player 18′. More specifically, the user is watching the movie with his children and gets an advance alert on his iPhone® from the alert generation function 32 of the media player 18′ regarding an inappropriate scene that the user does not wish to be viewed by his children. The user then immediately presses fast forward. The media player detects that only three 2-second segments are inappropriate and notifies the trick mode system. The media trick play function 26 then instructs the media player 18′ to display only those frames that specifically do not occur in the three 2-second segments during trick mode playback.

The user inadvertently fast forwards through too much by mistake. The media player 18′ then detects that the user is approaching a spoiler segment. Thus, the media trick play function 26 instructs the media player 18′ to specifically avoid the spoiler segment as well. The trick mode playback thus avoids showing any frames from the spoiler segment.

The present invention has substantial opportunity for variation without departing from the spirit or scope of the present invention. For example, while the embodiments discussed herein are directed to personal or in-home playback, the present invention is not limited thereto.

Those skilled in the art will recognize improvements and modifications to the preferred embodiments of the present invention. All such improvements and modifications are considered within the scope of the concepts disclosed herein and the claims that follow.

What is claimed is:

1. A method of smart trick mode display, comprising:
providing playback of a media item in a trick play mode;
analyzing a content of the media item during the trick mode playback of the media item;
identifying at least one segment of the content that is of interest to a user; and
displaying the at least one segment that is identified as being of interest to the user with emphasis to catch the user's attention during the trick mode playback of the media item.

2. The method of claim 1, wherein the media item is a recorded video.

3. The method of claim 2, wherein the at least one segment that is identified is emphasized during the trick mode playback of the recorded video by extracting and highlighting a keyframe representing the identified segment.

4. The method of claim 2, wherein the at least one segment that is identified is emphasized during the trick mode playback of the recorded video by extracting and playing the identified segment at one of a normal speed or a slower speed.

5. The method of claim 2, wherein the at least one segment that is identified is emphasized during the trick mode playback of the recorded video by deemphasizing any non-relevant content.

6. The method of claim 2, wherein the at least one segment that is identified is emphasized during the trick mode playback of the recorded video by playing the identified segment on a mobile device.

7. The method of claim 3, wherein highlighting of the extracted keyframe is carried out by pausing at the keyframe representing the identified segment for a longer time than other frames.

8. The method of claim 3, wherein highlighting of the extracted keyframe is carried out by marking the keyframe representing the identified segment with an icon.

9. The method of claim 8, wherein the icon indicates why the identified segment is relevant.

10. The method of claim 3, wherein highlighting of the extracted keyframe is carried out by overlaying the extracted keyframe in a picture-in-picture (PIP) format over remaining frames.

11. The method of claim 3, wherein highlighting of the extracted keyframe is carried out by displaying the extracted keyframe on a mobile device.

12. A method of smart trick mode display, comprising:
providing playback of a media item in a trick play mode;
analyzing a content of the media item during the trick mode playback of the media item;
identifying at least one segment of the content that is objectionable to a user and therefore should not be displayed to the user; and
avoiding the at least one segment that is identified as being objectionable to the user during the trick play mode playback of the media item.

13. The method of claim 12, further comprising alerting the user via a mobile device prior to the trick mode playback that at least one segment is identified as being objectionable to the user.

14. A media system with smart trick mode display, comprising:
a control system operative to:
provide playback of a media item in a trick play mode;
analyze a content of the media item during the trick mode playback of the media item;
identify at least one segment of the content that is of interest to a user; and
display the at least one segment that is identified as being of interest to the user with emphasis to catch the user's attention during the trick mode playback of the media item.

15. The media system of claim 14, wherein the media item is a recorded video.

16. The media system of claim 15, wherein the at least one segment that is identified is emphasized during the trick mode playback of the recorded video by extracting and highlighting a keyframe representing the identified segment.

17. The media system of claim 15, wherein the at least one segment that is identified is emphasized during the trick mode playback of the recorded video by extracting and playing the identified segment at one of a normal speed or a slower speed.

18. The media system of claim 15, wherein the at least one segment that is identified is emphasized during the trick mode playback of the recorded video by deemphasizing any non-relevant content.

19. The media system of claim 15, wherein the at least one segment that is identified is emphasized during the trick mode playback of the recorded video by playing the identified segment on a mobile device.

20. The media system of claim 16, wherein highlighting of the extracted keyframe is carried out by pausing at the keyframe representing the identified segment for a longer time than other frames.

21. The media system of claim 16, wherein highlighting of the extracted keyframe is carried out by marking the keyframe representing the identified segment with an icon.

22. The media system of claim 21, wherein the icon indicates why the identified segment is relevant.

23. The media system of claim 16, wherein highlighting of the extracted keyframe is carried out by overlaying the extracted keyframe in a picture-in-picture (PIP) format over remaining frames.

24. The media system of claim 16, wherein highlighting of the extracted keyframe is carried out by displaying the extracted keyframe on a mobile device.

25. A media system with smart trick mode display, comprising:
a control system operative to:
provide playback of a media item in a trick play mode;
analyze a content of the media item during the trick mode playback of the media item;
identify at least one segment of the content that is objectionable to a user and therefore should not be displayed to the user; and
avoid the at least one segment that is identified as being objectionable to the user during the trick play mode playback of the media item.

26. The media system of claim 25, wherein the control system is further operative to alert the user via a mobile device prior to the trick mode playback that at least one segment is identified as being objectionable to the user.

27. A mobile device comprising:
a communication interface communicatively coupling the mobile device to a media player; and
a control system associated with the communication interface and operative to:
provide playback of a media item in a trick play mode;
analyze a content of the media item during the trick mode playback of the media item;
identify at least one segment of the content that is of interest to a user; and
display the at least one segment that is identified as being of interest to the user with emphasis to catch the user's attention during the trick mode playback of the media item.

28. A mobile device comprising:
a communication interface communicatively coupling the mobile device to a media player; and
a control system associated with the communication interface and operative to:
provide playback of a media item in a trick play mode;
analyze a content of the media item during the trick mode playback of the media item;
identify at least one segment of the content that is objectionable to a user and therefore should not be displayed to the user; and
avoid the at least one segment that is identified as being objectionable to the user during the trick play mode playback of the media item.

29. A computer readable medium comprising software for instructing a media system to:
provide playback of a media item in a trick play mode;
analyze a content of the media item during the trick mode playback of the media item;
identify at least one segment of the content that is of interest to a user; and
display the at least one segment that is identified as being of interest to the user with emphasis to catch the user's attention during the trick mode playback of the media item.

30. A computer readable medium comprising software for instructing a media system to:
provide playback of a media item in a trick play mode;
analyze a content of the media item during the trick mode playback of the media item;
identify at least one segment of the content that is objectionable to a user and therefore should not be displayed to the user; and
avoid the at least one segment that is identified as being objectionable to the user during the trick play mode playback of the media item.

31. A method of smart trick mode display, comprising:
analyzing a content of a media item prior to a trick mode playback of the media item;
providing playback of the media item in the trick play mode;
identifying at least one segment of the content that is of interest to a user; and
displaying the at least one segment that is identified as being of interest to the user with emphasis to catch the user's attention during the trick mode playback of the media item.
